(19) United States
(12) Patent Application Publication
(10) Pub. No.: US 2025/0005636 A1
(43) Pub. Date: Jan. 2, 2025

(54) SERVER PROVIDING INFORMATION ON E-COMMERCE PLATFORM TO USERS AND METHOD OF OPERATING SERVER

(71) Applicant: CONIALAB CO., LTD., Seoul (KR)

(72) Inventor: HYUN JUNG NA, Gyeonggi-do (KR)

(21) Appl. No.: 18/755,199

(22) Filed: Jun. 26, 2024

(30) Foreign Application Priority Data
Jun. 27, 2023 (KR) 10-2023-0082746

(51) Int. Cl. G06Q 30/0601

(52) U.S. Cl. CPC G06Q 30/0607

(57) ABSTRACT

An e-commerce platform server includes a communication device, a memory configured to store one or more instructions, and a processor configured to execute the one or more instructions stored in the memory. The processor executes the one or more instructions to register suppliers' products in a platform service selling through an online shop of a seller and a content creator providing content for selling the products in a content creator DB, register content provided by the content creator in a content DB, post the content on at least one page on the e-commerce platform service, sell a product in the online shop through the at least one page, generate consulting information for creating content based on data collected in a process of selling the product, and provide the consulting information to the content creator.

### CROSS REFERENCE TO RELATED APPLICATIONS AND CLAIM OF PRIORITY

This application claims the benefit under 35 USC § 119 of Korean Patent Application No. 10-2023-0082746 filed on Jun. 27, 2023 in the Korean Intellectual Property Office, the entire disclosure of which is incorporated herein by reference for all purposes.

### BACKGROUND

### 1. Field

The Embodiments disclosed herein relate to a platform service technology for providing an e-commerce environment.

### 2. Description of Related Art

With the development of information and communication technology, online commerce, that is, e-commerce, which involves selling products by establishing an online market, has developed. The initial form of online commerce is that sellers directly open their own online shopping malls and register products and visitors who access the online shopping malls purchase the products, but, intermediate shopping malls that connect sellers and purchasers have emerged and provided convenient sales and purchasing services, growing into large shopping malls (e.g., Auction, 11th Street, G Market, or the like), and thus causing explosive growth in the e-commerce market. Since then, as various forms of e-commerce emerge in which social commerce using social networks (e.g., Timon, WeMakePrice) and innovative offline distribution and logistics services (e.g., Coupang) are combined, the explosive growth continues. The large-scale e-commerce platforms (e.g., large relay platforms, social commerce, or the like) are bringing a great profit to users, especially sellers.

Nowadays, a new type of e-commerce market using channels of individuals (e.g., influencers, celebrities, or the like) with great influence in social network services (SNSs) (e.g., Facebook, Instagram) and one-person media services (e.g., YouTube, TikTok) or using a strong personal network of a community of people with similar personal interests is being actively formed.

### SUMMARY

However, even if a seller sells a product using a large-scale e-commerce platform described above, the seller has to cover initial costs for marketing to sell the product (e.g., creating a product description page, advertising, or the like) and distributing the product. Furthermore, since the main source of income for the large-scale platforms is fees received from users, high fees may be charged to users, especially sellers, depending on the size of the platform. In addition, competition for the lowest price with multiple sellers within the platform may lower the seller' margin rate, which may lead to a decrease in product quality, causing damage to purchasers and, by extension, a platform service. Even if a platform operator and a small number of sellers get a great profit in the process, the concentrated profit structure may stagnate or deteriorate the development of the platform ecosystem. Further, large e-commerce platforms that focus on relaying product sales may have limitations that make it difficult to engage key members (e.g., influencers, communities, and the like) of the newly formed e-commerce market as new users through social network services (SNSs) and communities.

In addition, the existing e-commerce platform service is a platform service centered on product sales, and thus for content creation clients and content creators, it is difficult to connect with each other, and in particular, for content creators, it is often impossible to directly participate in the platform service, and so, the reality is that the content creators not only earn profits on the platform, but also have to rely on the subjective evaluation or limited information from the requester regarding the effect or feedback information on the content.

Accordingly, various embodiments of the present invention are directed to providing an e-commerce platform service where a content creator is capable of obtaining a reward by providing content to a platform service and receiving effectiveness and feedback information on the provided content.

In one general aspect, there is provided an e-commerce platform server including a communication device, a memory configured to store one or more instructions, and a processor configured to execute the one or more instructions stored in the memory, and the processor executes the one or more instructions to register suppliers' products in a platform service selling through an online shop of a seller and a content creator providing content for selling the products in a content creator DB, register content provided by the content creator in a content DB, post the content on at least one page on the e-commerce platform service, sell a product in the online shop through the at least one page, generate consulting information for creating content based on data collected in a process of selling the product, and provide the consulting information to the content creator.

In addition, the processor may execute the one or more instructions to determine at least one content item among a plurality of content item registered in the content DB based on the content of the specified content creator, generate consulting information based on data collected in the process of selling the product through a page where the at least one content item is posted, and provide the consulting information to the specified content creator.

In addition, the processor may execute the one or more instructions to determine the at least one content item based on a product corresponding to the content of the specified content creator.

In addition, the processor may execute the one or more instructions to determine content corresponding to a product in the same category as the product corresponding to the content of the specified content creator as the at least one content item.

In addition, the processor may execute the one or more instructions to determine a product category including a plurality of products corresponding to content items that are decided to be similar to each other by analyzing the plurality of content items registered in the content DB and determining content corresponding to a product of the same category as the at least one content item according to the determined category.

In addition, the processor may execute the one or more instructions to register the supply products of the supplier in a supply product DB, register a plurality of sellers with a hierarchy including at least one top seller and at least one sub seller subordinate to the at least one top seller, respectively, in a seller DB, register sale products of the top seller of the hierarchy in a sale product DB, the sale products being at least one of the supply products registered in the supply product DB, create an online shop of the sub seller that includes at least one of the registered sale products of the top seller to whom the sub seller is subordinate, and determine the at least one content item based on the hierarchy of sellers selling the product corresponding to the content through the page where the content of the specified content creator is posted.

In addition, the hierarchy of the plurality of sellers may include at least one seller group, each of the at least one seller group may include at least one sub seller subordinate to the top seller centered on the top seller, and the processor may execute the one or more instructions to determine the at least one content item to determine, as the at least one content item, content related to a seller group that includes a seller selling the product corresponding to the content.

In addition, the content related to a seller group may be content posted on at least one of sales pages of online shops of a plurality of sellers included in the seller group, and a content page of the content creator linked to the sales pages.

In addition, the processor may execute the one or more instructions to distribute a profit of the product sold through the at least one page to the content creator in a specified proportion and generate consulting information including data on the profit distributed by selling the product through a page where the at least one content item is posted, and information on content with a distributed profit that is at a specified rank or higher on the data.

In addition, the processor may execute the one or more instructions to post the content on a sales page of at least one online shop selling the product corresponding to the content and generate the consulting information based on data collected through the sales page.

In addition, the data may include the number of times the content is posted on the sales page of the online shop, and the number of times the product is sold through the posted sales page, and the processor may execute the one or more instructions to generate consulting information including information on content that is at a specified rank or higher based on at least one of the data and the number of times the content is posted and the number of times the product is sold on the data.

In addition, the processor may execute the one or more instructions to post the content on a content page of at least one content creator corresponding to the content and generate the consulting information based on data collected through the content page.

In addition, the data may include the number of times the content is viewed by users on the platform service, and the number of times the viewing users access the sales page through the content, and the processor may execute the one or more instructions to generate consulting information including information on content at a specified rank or higher based on at least one of the data and the number of times the content is viewed on the data and the number of times the users access the sales page on the data.

In another general aspect, there is provided a method of providing an e-commerce platform service, the method including registering a content creator who provides content for selling suppliers' products in a content creator DB in a platform service in which the products are sold through an online shopping shop of a seller, registering content provided by the content creator in a content DB, posting the content on at least one page on the platform service, selling a product in the online shop through the at least one page, generating consulting information for creating content based on data collected in a process of selling the product, and providing the consulting information to the content creator.

In another general aspect, there is provided a computer program including an instruction to register a content creator who provides content for selling suppliers' products in a content creator DB in a platform service in which the products are sold through an online shopping shop of a seller, an instruction to register content provided by the content creator in a content DB, an instruction to post the content on at least one page on the platform service, an instruction to sell a product in the online shop through the at least one page, an instruction to generate consulting information for creating content based on data collected in a process of selling the product, and an instruction to provide the consulting information to the content creator.

### BRIEF DESCRIPTION OF THE DRAWINGS

FIG. 1 is a diagram illustrating an e-commerce environment according to various embodiments.

FIG. 2 is a diagram illustrating a configuration of an e-commerce platform server according to one embodiment.

FIG. 3 is a diagram illustrating a hierarchy of sellers according to one embodiment.

FIG. 4 is a diagram illustrating a plurality of seller groups included in a hierarchy of sellers according to one embodiment.

FIGS. 5A and 5B are diagrams illustrating a process in which content is provided on an e-commerce platform according to one embodiment.

FIG. 6 is a view illustrating that a content creator's content is posted on a sales page of a seller's online shop according to one embodiment.

FIGS. 7A and 7B are views illustrating that content is posted on a content creator's content page according to one embodiment.

FIG. 8 is a view illustrating a graphic user interface (GUI) that provides status information about a content creator according to one embodiment.

FIG. 9 is a view illustrating a GUI that provides consulting information to a content creator according to one embodiment.

FIG. 10 is a flowchart showing a method of providing consulting information to a content creator according to one embodiment.

### DETAILED DESCRIPTION

Hereinafter, various embodiments disclosed in the present disclosure will [symbol] be described with reference to the accompanying drawings. However, this is not intended to limit the present disclosure to the specific embodiments, and it is to be construed to include various modifications, equivalents, and/or alternatives of embodiments of the present disclosure.

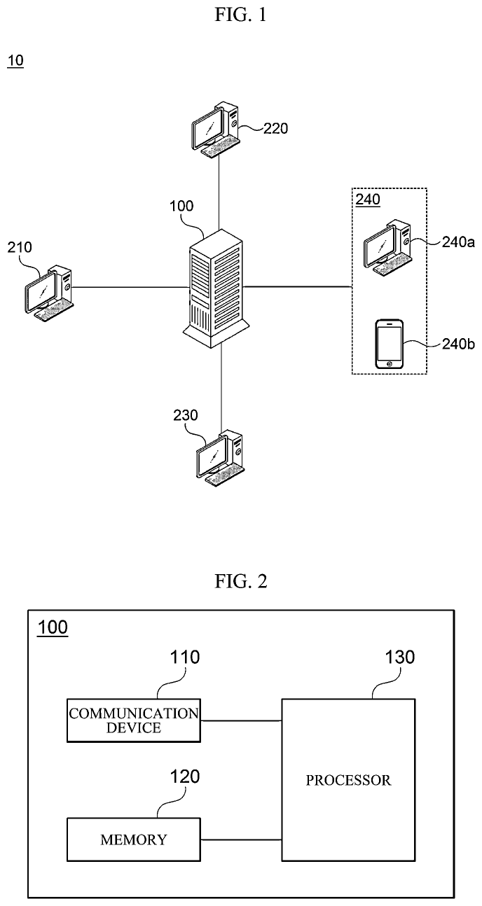

FIG. 1 is a diagram illustrating an e-commerce environment according to various embodiments.

Referring to FIG. 1, an e-commerce environment 10 may include a platform server 100, a supplier terminal 210, a seller terminal 220, a content creator terminal 230, and a purchaser terminal 240. The platform server 100 may be connected to the supplier terminal 210, the seller terminal 220, the content creator terminal 230, and the purchaser terminal 240 through a communication network.

The platform server 100 may provide an e-commerce platform service through the user terminals 210, 220, 230, and 240. The e-commerce platform service may include overall services required to sell products online, such as product supply, sales, promotion, and purchase.

According to one embodiment, the platform server 100 may provide a supplier with the services necessary to supply platform products through the supplier terminal 210.

According to one embodiment, the platform server 100 may register a supplier of a product to be sold through the supplier terminal 210 in the platform service. The supplier may be, for example, a person who supplies products to be sold in the platform service and delivers products sold by a seller. Accordingly, the supplier may be a person who is only responsible for product distribution and delivery and leaves the rest to other users. According to one embodiment, registering in the platform service may be understood as registering in the platform service as a participant performing a specified role. According to one embodiment, the supplier may be approved for registration according to specified criteria. The specified criteria may include, for example, criteria for determining the reliability of the supplier, such as a business period, a capital size, a sales size, a brand value, or the like. According to one embodiment, the supplier may be approved according to strict (or high) criteria. Accordingly, products may be stably supplied on the platform by highly reliable suppliers.

According to one embodiment, the platform server 100 may register the supplier's supply products in the platform service through the supplier terminal 210. According to one embodiment, a product may be approved for registration according to specified criteria. The specified criteria may include, for example, criteria for predicting product sales volume, such as product quality, consumer preference, brand involvement, market share, a distribution margin structure, availability of exclusive distribution, and the like. According to one embodiment, a product may be approved according to strict criteria. Accordingly, users (e.g., sellers, content creators) capable of contributing to promoting product sales by registering products with high sales volume may participate more in the platform service, generating high synergy.

According to one embodiment, the platform server 100 may provide a total solution required to supply products through the supplier terminal 210. For example, the platform server 100 may provide a solution that includes services for registering and selling supply products and managing a community. Services for managing product sales may include, for example, services that provide sales information for registered supply products, manage inventory of supply products, and manage orders, delivery, and refunds. According to one embodiment, the platform server 100 may provide settlement information about products sold through a seller's online shop.

According to one embodiment, the platform server 100 may provide the seller with services required to sell products through the seller terminal 220.

According to one embodiment, the platform server 100 may register the seller in the platform service through the seller terminal 220. The seller may be, for example, a person who sells the supply product registered in the platform service by the supplier. According to one embodiment, sellers may be structured in a hierarchy. The hierarchy may, for example, include an upper seller and a sub seller subordinate to the upper seller. According to one embodiment, the sub seller who is subordinate to the upper seller may be subordinate to the upper seller in terms of products to be sold and sales conditions, and may be required to pay a portion of the sales amount as a commission to the upper seller. According to one embodiment, a seller may be approved for registration according to specified criteria. The specified criteria may be differently applied depending on, for example, the seller's layer. A top seller may be approved for registration based on strict criteria based on reliability equivalent to that of a supplier, such as sales size, a capital size, a human network size, and the like. Sub sellers (e.g., a second-layer seller, a third-layer seller) may be registered in the platform service with the approval of the upper seller. Accordingly, the supply product registered in the platform service may be professionally sold in various of ways in multiple online shops (or online shopping malls) under the direction of a highly reliable top seller.

According to one embodiment, the platform server 100 may register the seller's sale products in the platform service through the seller terminal 220. For example, the platform server 100 may register sale products of the top seller. In other words, the platform server 100 may allow only the top seller to apply for approval for sale of new products. For example, the sub seller of the top seller is not allowed to directly apply for sales approval of new products, but is allowed to select and sell products from within the products approved for sale by the top seller. According to one embodiment, a sale product may be approved according to specified criteria. The sale product may include, for example, criteria for determining whether the product may be sold professionally, such as the seller's activity area, capital size, existing sale products, sales volume, or the like. According to one embodiment, approval criteria for the sale product may be high. Accordingly, product information on the supply product registered in the platform service may be delivered to purchasers with high interest in the product through appropriate marketing methods by a professional seller, thereby recording high sales, which may bring a great profit not only to the supplier but also to users who contribute to product sales (e.g., the seller and the content creator).

According to one embodiment, the platform server 100 may provide a solution for creating an online shop within the platform. For example, the platform server 100 may provide a function of setting up an online shop using a drag and drop method through the GUI without hard coding. In addition, the platform server 100 may provide a pre-made design template. According to one embodiment, the platform server 100 may register a seller's sale product in an online shop. For example, the sale product may be a product approved for sale to the seller. According to one embodiment, the platform server 100 may create an online shop requested by the seller. For example, the platform server 100 may create an online shop created by each seller. Each seller may create a separate online shop according to his or her tastes. Accordingly, purchasers may selectively join an online shop that suits their tastes on the platform service and purchase products registered in the online shop as a member.

According to one embodiment, the platform server 100 may provide a sales service for products registered in the created online shop to users who visit the platform. For example, the platform server 100 may allow a user who directly visits the platform to search for products through a route within the platform (e.g., search, online shop visit) and purchase the products that are found by the searching. For example, information on products registered in the online shop may not be found by searching through a portal service (e.g., Naver and Yahoo). Accordingly, it is possible to increase user loyalty to platform services and prevent losses to suppliers and sellers due to excessive competition at the lowest prices.

According to one embodiment, the platform server 100 may provide a comprehensive solution required to sell products through the seller terminal 220. For example, the platform server 100 may provide a solution that includes services for managing the online shop and managing human resources, registration of sale products, sales of sale products, and a community of the online shop. The service for managing human resources may include, for example, a service for managing sub sellers and members. The service for managing product sales may include a service that provide sales information about products to be sold, and a service that manages orders, delivery, and refunds. According to one embodiment, the platform server 100 may provide settlement information about products sold through a seller's online shop. According to one embodiment, the platform server 100 may provide status information about the sub seller subordinate to the upper seller in the hierarchy. The status information may include, for example, information about human resources, product sales, and a community. According to one embodiment, the platform server 100 may provide a comprehensive solution required to sell products through the GUI.

According to one embodiment, the platform server 100 may provide a service required to supply content to the supplier through the content creator terminal 230.

According to one embodiment, the platform server 100 may register a content creator in the platform service. For example, the content creator may provide the supplier and the seller with content for selling the supplier's products (or supply products) through the online shop of the seller. According to one embodiment, the content creator may be an expert who is directly or indirectly required to create content. The expert may include, for example, a model, a hair and makeup expert, a stylist, a photographer, and the like. In addition, the model may be an influencer, celebrity, or the like, on online social media.

According to one embodiment, the platform server 100 may register content provided by the content creator in the platform service. The content may include, for example, images such as photos for selling products. In other words, the content may include images to promote products. According to one embodiment, the content may include the content creator directly as a model. In addition, the content may be planned or prepared (e.g., makeup or the like) by the content creator.

According to one embodiment, the platform server 100 may post the registered content on a specified page on the platform service. The page on the platform service may be, for example, a document containing information such as text, photos, video, and sound prepared online (or on the web) to provide the e-commerce platform service, and may be posted on a browser (e.g., a general-purpose browser, dedicated application, or the like) when a specified address (e.g., URL) is entered. According to one embodiment, the platform service may include a plurality of pages organically linked to each other to provide the e-commerce platform service.

According to one embodiment, the platform server 100 may post the registered content to an online shop. For example, the platform server 100 may post the content on a sales page of an online shop that sells the product corresponding to the content. For example, the online shop may be an online shop of a seller registered in the platform service. According to one embodiment, the platform server 100 may post the registered content on a sales page of the online shop according to a request from the seller. Accordingly, the seller may use the content to promote product sales.

According to one embodiment, the platform server 100 may post the registered content on a content page of the content creator. The content page is, for example, a page where a specified content creator is identifiable, and a plurality of content items created by the specified content creator may be posted. According to one embodiment, the content posted on the content page may be linked to a page for selling a corresponding product. The page for selling the product may be, for example, a sales page of an online shop of a seller registered in the platform service. Accordingly, the content creator may promote himself or herself through the content page to expand his or her influence on the platform and promote product sales in the online shop.

According to one embodiment, the platform server 100 may provide a service that allows content created by the content creator to be shared with platform users through the content page. For example, the platform server 100 may provide a content sharing service using platform users as a social network, in other words, a social network service (SNS). According to one embodiment, the platform server 100 may provide the content registered in the platform service to the platform users through the content sharing service. According to one embodiment, the content posted on the content sharing service may include information (e.g., URL) about an online shop within the platform where a corresponding product is being sold. Accordingly, the purchaser may move to a specified shopping mall using the information and purchase the product. According to one embodiment, the platform server 100 may provide information about experts who have participated in content creation (e.g., a model, a hair and makeup expert, a stylist, a photographer, and the like) together with the content. Accordingly, the platform users (e.g., the supplier, seller, and purchaser) may easily confirm not only the model but also all parties required to create content.

According to one embodiment, the platform server 100 may distribute the profit from sold products to the content creator. For example, when a product is sold through a page where content is posted, the platform server 100 may distribute the profit of the sold product in a specified proportion. A page where the content is posted may be, for example, a sales page of the online shop, and a content page of the content creator linked to the sales page. Accordingly, the content creator may receive a reward for content creation through the e-commerce platform service.

According to one embodiment, the platform server 100 may provide a service for connecting the supplier and the seller to the content creator. According to one embodiment, the platform server 100 may connect the supplier and the seller who wish to request the creation of content for product promotion to the content creator. For example, the platform server 100 may connect not only a model matching an image of the product but also participants required to create content, such as a hair and makeup expert, a stylist, and the like, all at once. According to one embodiment, the platform server 100 may connect the supplier and the seller who want to offer product sponsorship to a content creator. According to one embodiment, the platform server 100 may connect a content creator who is expected to create content with high promotional effectiveness to the supplier and the seller. For example, the platform server 100 may connect a content creator who is expected to have a high promotional effect based on sales or the like of previously created content, the product of the created content.

According to one embodiment, the platform server 100 may provide consulting information for creating content to the content creator. In other words, the platform server 100 may provide consulting information helpful in creating content to the content creator. According to one embodiment, the platform server 100 may determine at least one content item of which a promotional effect may be compared to specified content, based on the specified content. For example, the platform server 100 may determine at least one content item among content items registered on the platform service based on information about products and sellers related to the specified content. According to one embodiment, the platform server 100 may generate the consulting information based on data collected in the process of selling the product through a page where the determined at least one content item is posted. For example, the platform server 100 may generate the consulting information based on data on the profit distributed to content and data collected through a specified page (e.g., the sales page and content page). According to one embodiment, the platform server 100 may provide the generated consulting information to the content creator. Accordingly, the content creator may receive a great profit by creating content with reference to the consulting information.

According to one embodiment, the platform server 100 may provide the content creator with a comprehensive solution required to supply content through the content creator terminal 230. For example, the processor 130 may provide a solution including services for managing contracts, profits, and settlements with the supplier and the seller. According to one embodiment, the platform server 100 may provide profit information according to content creation. The profit information may include, for example, information about money distributed based on sales of the product corresponding to the created content. According to one embodiment, the platform server 100 may provide consulting information for creating content. For example, the consulting information may include information helpful in creating highly profitable content. According to one embodiment, the platform server 100 may provide a solution required to supply content through the GUI.

According to one embodiment, the platform server 100 may provide a purchaser with a service required to purchase a product through the purchaser terminal 240.

According to one embodiment, the platform server 100 may register a purchaser as a member in the seller's online shop. For example, the platform server 100 may register a purchaser as a member in each seller's online shop.

According to one embodiment, the platform server 100 may receive order and delivery information about a purchaser who purchases a product through an online shop. According to one embodiment, the platform server 100 may provide a payment service to a purchaser who purchases a product. According to one embodiment, the platform server 100 may transmit order information to the supplier and the seller when payment is completed. Accordingly, the supplier may deliver the ordered product to the purchaser.

According to one embodiment, the platform server 100 may provide a service for managing an order status through the purchaser terminal 240. According to one embodiment, the platform server 100 may provide order and delivery information for the product purchased from the online shop. According to one embodiment, when the platform server 100 receives order correction information, the platform server 100 may modify the order information based on the received correction information.

According to one embodiment, a manager of the platform server 100 may approve the registration of the platform service. According to one embodiment, the manager of the platform server 100 may approve registration of the platform user. For example, the manager may approve registration of the supplier and the seller. The seller for registration approval may be, for example, a top seller. According to one embodiment, the manager of the platform server 100 may approve registration of a product. For example, the manager may approve a supply product of the supplier and a sale product of the seller. For example, the sale product may be a sale product of the top seller. According to one embodiment, the manager of the platform server 100 may access the platform server 100 through a separate terminal and approve registration of the service.

According to one embodiment, the manager of the platform server 100 may confirm status information for managing the overall status of the supplier and the seller. The status information may include, for example, sales information (e.g., sales information, settlement information, delivery information, or the like), settlement information, and order and delivery information. According to one embodiment, the manager of the platform server 100 confirm community information. The community information may include, for example, an online shop, and notices, FAQs, Q&A, reviews, and the like, about products sold in the online shop.

According to one embodiment, the manager of the platform server 100 may register suppliers, sellers, and content creators introduced by a collector according to the above-described procedure. According to one embodiment, the collector is a separate entity from the manager and may play a role in encouraging more users to participate in the platform service.

According to one embodiment, the platform server 100 may include not only a computing module required to provide the e-commerce platform service, but also a database (DB) for data storage. In other words, the platform server 100 may include a server configuration generally required to provide the e-commerce service. According to one embodiment, the platform server 100 may provide useful information to service users by analyzing information stored in the database. The useful information may include, for example, basic data useful for product supply, product sales, content creation, and product purchase, and processed data.

The supplier terminal 210 may be a supplier terminal for using the e-commerce platform service provided to the supplier from the platform server 100.

According to one embodiment, the supplier terminal 210 may receive information for managing product supply from the platform server 100. For example, the supplier terminal 210 may receive information for registering a supply product, selling the supply product, and managing a community for the supply product. According to one embodiment, the supplier terminal 210 may transmit, to the platform server 100, information input from the supplier for managing product supply. For example, the supplier terminal 210 may transmit application information for registering a new supply product. In addition, the supplier terminal 210 may transmit information input from the supplier to manage orders, delivery, and a community of the supply product. According to one embodiment, the supplier terminal 210 may provide information for managing product supply to the supplier through the GUI and receive information required to manage product supply from the supplier.

The seller terminal 220 may be a seller's terminal for using the e-commerce platform service provided to the seller from the platform server 100.

According to one embodiment, the seller terminal 220 may receive a service for creating a shopping mall provided from the platform server 100. The service for creating an online shop may include information required to create a shopping mall, for example, in a manner of dragging and dropping through the GUI and providing a template. According to one embodiment, the seller terminal 220 may transmit information input from the seller to the platform server 100 to create an online shop. Accordingly, the seller's online shop may be created on the platform.

According to one embodiment, the seller terminal 220 may receive information for managing product sales from the platform server 100. For example, the seller terminal 220 may receive information for registering sale products, selling the sale products, managing human resources, and managing an online shop community. The human resource management may include, for example, managing sub sellers and members. According to one embodiment, the seller terminal 220 may transmit information input from the seller to the platform server 100 to manage product sales. For example, the seller terminal 220 may transmit an application to register a new sale product. The application for the new sale product may be done, for example, by the top seller. In addition, the seller terminal 220 may transmit information input from the seller to manage orders, delivery, and a community of the supply product. According to one embodiment, the seller terminal 220 may provide information for managing product supply to the seller through the GUI and receive information required to manage product sales from the seller.

The content creator terminal 230 may be a seller terminal for using the e-commerce platform service provided to the content creator from the platform server 100.

According to one embodiment, the content creator terminal 230 may be provided with a service for sharing content with platform users from the platform server 100. The service for sharing the content may be, for example, a social network service (SNS) using platform users as a social network. According to one embodiment, the content creator terminal 230 may transmit a created content to the platform server 100. Accordingly, the content creator's content may be shared on the platform.

According to one embodiment, the content creator terminal 230 may receive content creating request and sponsorship offer information from the platform server 100. According to one embodiment, the content creator terminal 230 may transmit a response indicating acceptance of the creation request and sponsorship offer to the platform server 100. Accordingly, a content creation or sponsorship contract with the supplier or seller may be made.

According to one embodiment, the content creator terminal 230 may receive information for managing content creation from the platform server 100. For example, the content creator terminal 230 may receive contract information, profit information, and settlement information from the platform server 100. According to one embodiment, the content creator terminal 230 may receive consulting information for creating content from the platform server 100. According to one embodiment, the content creator terminal 230 may provide the received information to the seller through the GUI and receive information required to manage content creation and sponsorship contracts from the content creator.

The purchaser terminal 240 may be a purchaser terminal for using the e-commerce platform service provided to the purchaser from the platform server 100.

According to one embodiment, the purchaser terminal 240 may receive online shop information. According to one embodiment, the purchaser terminal 240 may transmit information on a consumer's order. Accordingly, a product purchase may be made.

According to one embodiment, the user terminals 210, 220, 230, and 240 may be a general-purpose device such as a desktop personal computer, a laptop PC, a smartphone, a tablet PC, and a personal digital assistant (PDA). For example, the supplier terminal 210, the seller terminal 220, and the user terminal 230 may be electronic devices with relatively low portability, such as desktop PCs and laptop PCs, and the purchaser terminal 240 may be a smartphone 240b as well as a desktop PC 240a with low portability.

In the e-commerce environment 10 described above, suppliers who supply products, sellers who create online shops to sell products, and creators who create content to promote products may coexist on one platform and provide an e-commerce platform service that sells products to purchasers and shares the profit from product sales.

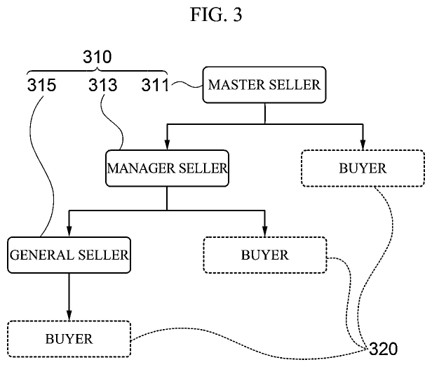

FIG. 2 is a diagram illustrating a configuration of an e-commerce platform server according to one embodiment.

Referring to FIG. 2, a platform server 100 may include a communication device 110, a memory 120, and a processor 130. However, not all of the components illustrated are essential components. The platform server 100 may be implemented with more components than the illustrated components, and the platform server 100 may be implemented with fewer components than the illustrated components.

The communication device 110 may communicate with an external device. For example, the communication device 110 may be connected to a network by wire or wirelessly to communicate with an external device. Here, the external device may be a user terminal (e.g., the user terminals 210, 220, 230, and 240 in FIG. 1).

The communication device 110 may include a communication module that supports one of various wired and wireless communication methods. The communication module may be a short-distance communication module or a wired communication module.

The memory 120 may include at least one storage medium of a flash memory type memory, a hard disk type memory, a multimedia card micro type memory, a card type memory (SD memory, XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc.

The memory 120 may store at least one program for providing product supply, product sales, content provision, and an e-commerce platform service in which buying users participate on the platform server 100. The at least one program stored in the memory 120 may be classified into a plurality of modules according to function.

The memory 120 may include a DB for registering information on products, suppliers, sellers, content creators, and purchasers. However, the DB is a separate storage device and may be implemented outside of the platform server 100 and connected directly or through a communication network.

The processor 130 may control the overall operation of the platform server 100 and include at least one processor such as a CPU. The processor 130 may include at least one specialized processor corresponding to each function, or may be an integrated processor.

The processor 130 may execute a program stored in the memory 120, read data or files stored in the memory 120, or store a new file in the memory 120. In addition, the processor 130 may execute instructions stored in the memory 120. Accordingly, the processor 130 may perform the following operations.

The operation performed by instruction execution of the processor 130 may be understood as the operation of a platform server (e.g., the platform server 100 in FIG. 1).

According to one embodiment, the processor 130 may register a supplier of a product to be sold in the platform service in a supplier DB through a supplier terminal (e.g., the supplier terminal 210 in FIG. 1). According to one embodiment, registering in the DB may be understood as storing information about a subject to be registered. In addition, storing information about the subject in the DB may be understood as registering the subject in the platform service.

According to one embodiment, the processor 130 may register a supply product in a supply product DB through the supplier terminal. The supply product may be, for example, a supplier's product to be sold on the platform service.

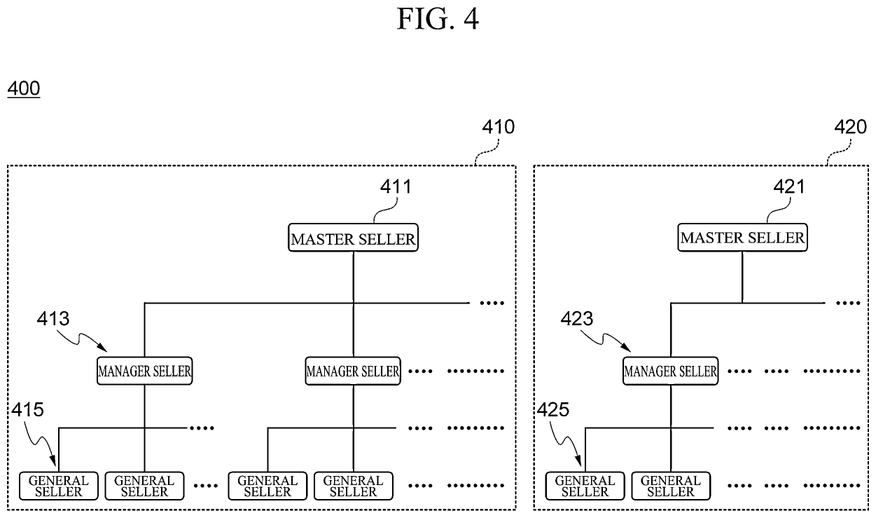

According to one embodiment, the processor 130 may register a seller in a seller DB through a seller terminal (e.g., the seller terminal 220). For example, when registering a plurality of sellers in the seller DB, the processor 130 may register the sellers in the seller DB in a hierarchy including an upper seller and at least one sub seller subordinate to the upper seller. According to one embodiment, in the seller DB, the processor 130 may register a top seller in the hierarchy as a master seller, and register a sub seller subordinate to the top seller as a manager seller and register a sub seller subordinate to the manager seller as a general seller. According to one embodiment, the processor 130 may grant designated authority to the manager seller to manage the general seller. This will be described in more detail in FIGS. 3 and 4.

According to one embodiment, the processor 130 may register a sale product in a sale product DB through the seller terminal. For example, the processor 130 may register the top seller's sale products in the sale product DB. For example, the sale product may be at least one of the supply products registered in the supply product DB. In other words, at least one of the supply products registered by the suppliers may be selected and registered as a sale product.

According to one embodiment, the processor 130 may allow sub sellers subordinate to the top seller to sell products within the top seller's registered sale products. In other words, the products sold by the sub sellers are subordinate to the registered sale products of the top seller to whom the sub sellers are subordinate.

According to one embodiment, the processor 130 may create an online shop for each of a plurality of sellers registered through the seller terminal. For example, the processor 130 may create online shops for sub sellers subordinate to the top seller. For example, the created online shop may include at least one of the registered sale products of the top seller registered in the sale product DB. In addition, online shops of not only the sub sellers but also the top seller may be created.

According to one embodiment, the processor 130 may set an earning rate for distributing the profit from the sale of products through the seller terminal. According to one embodiment, the processor 130 may receive information for setting the earning rate of the seller according to the hierarchy from the terminal of the top seller. According to one embodiment, the processor 130 may set the earning rate for sellers in the hierarchy according to information for setting the received earning rate. The set earning rate may be for distribution of the profits, for example, the amount obtained by excluding a supply price of the supplier and a content creator's contribution from the amount of the sale of products.

According to one embodiment, the processor 130 may register a content creator in a content creator DB through a content creator terminal (e.g., the content creator terminal 230 in FIG. 1). For example, the processor 130 may register a content creator who provides content for selling the supplier's product in the content creator DB, in the platform service that sells the product through the seller's online shop. The content creator may be, for example, an expert (e.g., a model, a hair and makeup expert, a stylist, a photographer, or the like) who has directly or indirectly participated in creating the content. According to one embodiment, the processor 130 may receive application information for registering as a content creator from the content creator terminal. The application information may include, for example, information capable of identifying a content creator. According to one embodiment, the processor 130 may register a content supplier based on the received application information.

According to one embodiment, the processor 130 may register the content provided by the content creator in the content DB. For example, the processor 130 may register content corresponding to the product sold in an online shop of the platform service in the content DB. The registered content may include, for example, images such as photos and videos to promote the corresponding product. According to one embodiment, the processor 130 may receive content and information on the content from the content creator terminal. The information on the content may include, for example, information about an expert (e.g., a model, a hair and makeup expert, a stylist, a photographer, or the like) who has participated in creating the content. According to one embodiment, the processor 130 may register the content together with the content information.

According to one embodiment, the processor 130 may post the registered content on at least one page on the platform service. For example, the processor 130 may post the content on at least one of a sales page of the online shop and a content page of the content creator linked to the sales page.

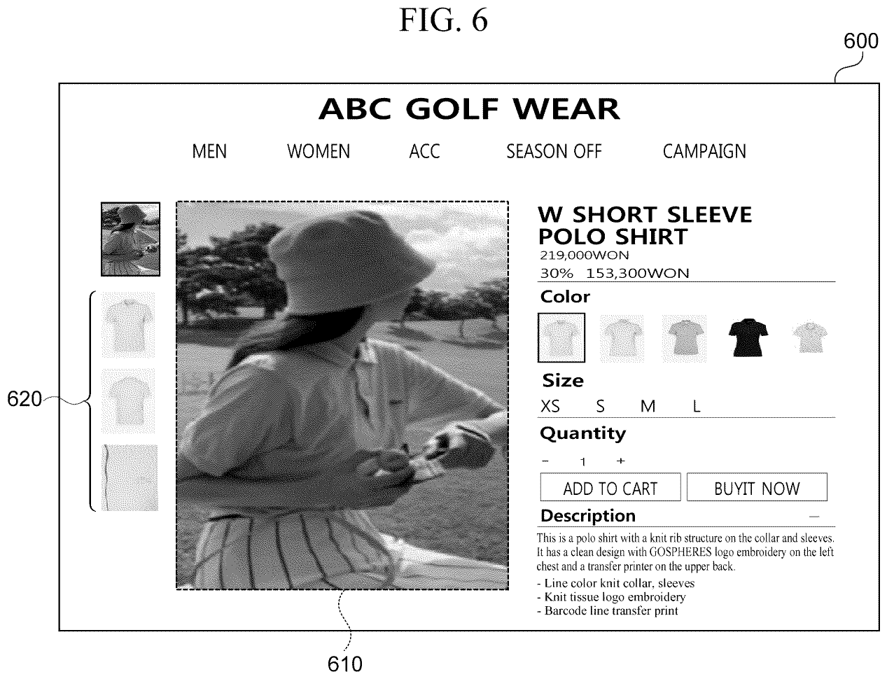

According to one embodiment, the processor 130 may post content on a sales page of the online shop that sells the product corresponding to the content. For example, the processor 130 may post the content on a sales page that sells products included in the content. The sales page may be, for example, a page where products are directly sold. According to one embodiment, the processor 130 may post the content creator's content on the sales page together with product description. The product description may include content (e.g., an image) provided by the supplier, for example. This will be described in more detail in FIG. 6.

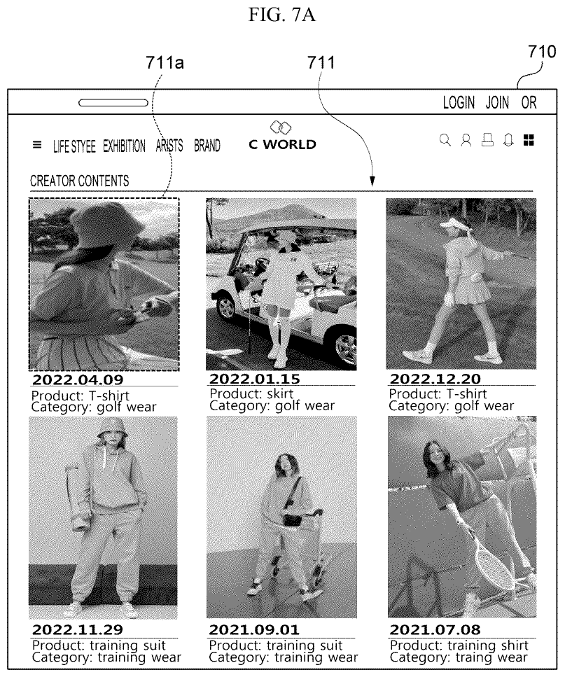

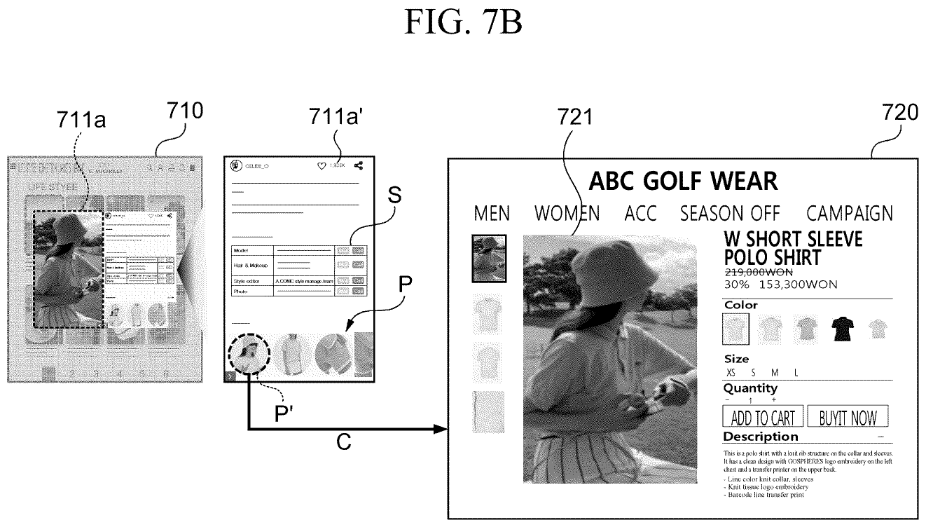

According to one embodiment, the processor 130 may post content on the content page of the content creator corresponding to the content. For example, the processor 130 may post the content on the content page of the content creator who has created the content. The content page may include, for example, a plurality of content items from a corresponding content creator. According to one embodiment, the processor 130 may set the content posted on the content page to be linked to a page for selling a product corresponding to the content. For example, the processor 130 may include information about the sales page (e.g., URL) in product information posted together with the content. Accordingly, purchasers may purchase the product indirectly through the content page. According to one embodiment, the processor 130 may post the information on the content together with the content on the content page. The information on the content may include not only product information but also information about the content creator (e.g., a model, a hair and makeup expert, a stylist, a photographer, or the like). This will be described in more detail in FIGS. 7A and 7B.

According to one embodiment, the processor 130 may sell a product in an online shop through at least one page where the content is posted. For example, the processor 130 may sell a product corresponding to the content through the at least one page. According to one embodiment, the processor 130 may sell a product through a sales page of an online shop where the content is directly posted. According to one embodiment, the processor 130 may indirectly sell a product through a content page linked to a sales page of an online shop.

According to one embodiment, the processor 130 may distribute a profit of the product sold through at least one page where the content is posted to the content creator in a specified proportion. For example, the processor 130 may distribute the profit of the product sold through the sales page of the online shop where the content is posted to the content creator in a specified proportion. For another example, the processor 130 may distribute the profit of the product sold through the sales page of the online shop linked to the content page of the content creator where the content is posted to the content creator in a specified proportion. The specified proportion may be determined, for example, by a person who has requested content creation (e.g., the supplier or seller).

According to one embodiment, the processor 130 may provide a service for connecting the supplier and the seller to the content creator through the content creator terminal. For example, the processor 130 may request content creation for promoting a product or connect a content creator for product sponsorship. According to one embodiment, the processor 130 may upload the connected content to the seller's online shop and provide the content to users of the platform service. For example, the processor 130 may provide a product purchase page with the uploaded content through a purchaser terminal.

According to one embodiment, the processor 130 may provide recommendation information on content creators expected to have a high promotional effect through the supplier terminal and the seller terminal. The recommendation information may be provided, for example, based on information about content that has been previously created.

According to one embodiment, the processor 130 may generate the consulting information for creating content based on data collected in the process of selling the product through at least one page where the content is posted.

According to one embodiment, the processor 130 may determine at least one content item among a plurality of content items registered in the content DB based on the content of a specified content creator. For example, the at least one content item may be a content item of another content creator that may be compared with the content of the specified content creator to generate the consulting information.

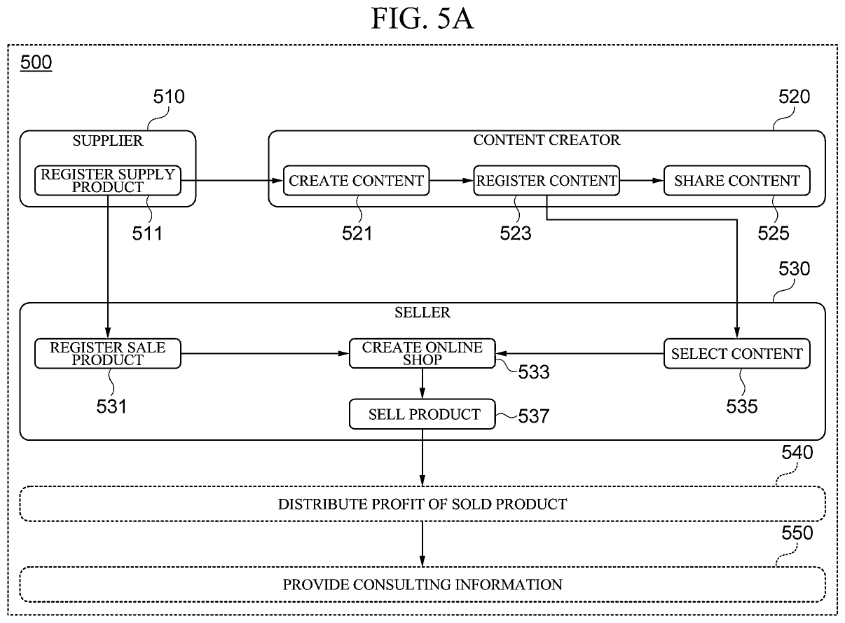

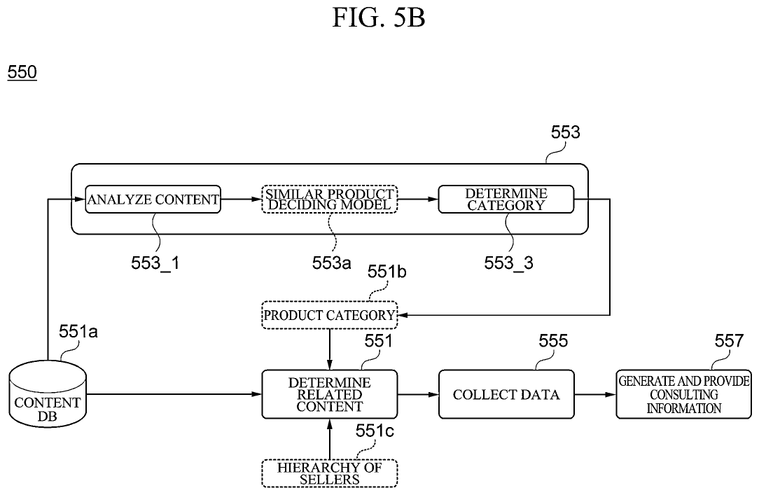

According to one embodiment, the processor 130 may determine at least one content item based on the product corresponding to the content of the specified content creator. For example, the processor 130 may determine content corresponding to a product in the same category as the product corresponding to the content of the specified content creator as the at least one content item. The product category for deciding a product in the same category may be determined, for example, by considering the product market, consumers, content, and the like. According to one embodiment, the processor 130 may determine a product category including a plurality of products corresponding to content items that are decided to be similar to each other among the plurality of content items registered in the content DB. For example, the processor 130 may analyze the plurality of registered content items and determine categories so that products corresponding to content items with the same specified elements are included in one category. The specified elements may include, for example, images, types of content, experts involved in creating the content, and the like. According to one embodiment, the processor 130 may determine content corresponding to the product of the same category as the at least one content item according to the determined category. According to one embodiment, since the category targets only products (e.g., supply products) registered on the platform service, the category may be more sophisticated in terms of generating consulting information for content creation than an arbitrarily determined category. Accordingly, the product category may be a criterion for determining content comparable to specified content to generate consulting information. This will be described in more detail in FIG. 5B.

According to one embodiment, the processor 130 may determine the at least one content item based on the hierarchy of sellers selling the product corresponding to the content through the page where the content of the specified content creator is posted.

According to one embodiment, the processor 130 may determine, as the at least one content item, content related to a seller group that includes a seller selling the product corresponding to the content. The content related to a seller group may be, for example, content posted on at least one of sales pages of online shops of a plurality of sellers included in the seller group, and a content page of the content creator linked to the sales pages. According to one embodiment, the seller group may include at least one sub seller subordinate to the top seller centered on the top seller in the hierarchy. The top seller may be, for example, a master seller. Since a plurality of sellers included in the seller group sell products of the top seller that are relevant to each other, the seller group may be a criterion for determining content to generate consulting information helpful in creating content. This will be detailed in more detail in FIG. 4.

According to one embodiment, the processor 130 may determine content posted in at least one of a sales page of an online shop of a sub seller of the plurality of sellers included in the seller group and a content page linked to the sales page, as the at least one content item. In other words, the plurality of sellers included in the seller group may be sub sellers of the seller group. The sub seller may be, for example, a general seller. Since the sub seller may be a seller whose main role is selling products, content related to the sub seller may be more suitable for generating consulting information than content of the upper seller. This will be described in more detail in FIG. 3.

According to one embodiment, the processor 130 may generate the consulting information based on data collected in the process of selling the product through a page where the determined at least one content item is posted.

According to one embodiment, the processor 130 may generate the consulting information based on data on the profit distributed by selling the product through a page where at least one content item is posted. For example, the processor 130 may generate consulting information including data on the profit distributed to the at least one content item, and Information on content whose distributed profit is at a specified rank or higher in the data. The information on the content may include, for example, products and models directly included in the content, as well as information about an expert who has participated in creating the content. According to one embodiment, the data on the profit may be data that represents the overall effect of content on product sales. Accordingly, the content creator may obtain information for creating content capable of getting a great profit through the generated consulting information.

According to one embodiment, the processor 130 may provide the consulting information based on data collected through the sales page where at least one content item is posted. The collected data may include, for example, the number of times the content is posted on the sales page of the online shop, and the number of times the product is sold through the posted sales page. According to one embodiment, the processor 130 may generate consulting information including information on content at a specified rank or higher based on at least one of the data and the number of times the content is posted and the number of times the product is sold on the data. According to one embodiment, data collected through the sales page may be data that directly represents the effect of content on product sales. Accordingly, the content creator may obtain information for creating content capable of increasing the product sales through the consulting information.

According to one embodiment, the processor 130 may provide the consulting information based on data collected through the content page where at least one content item is posted. The collected data may include, for example, the number of times content is viewed by users on the platform service, and the number of times the users access the sales page through the content. According to one embodiment, the processor 130 may generate consulting information including information on content at a specified rank or higher based on at least one of the data and the number of times the content is viewed and the number of times the users access the sales page on the data. According to one embodiment, data collected through the content page may be data that indirectly represents the effect of content on product sales. Accordingly, the content creator may obtain information for creating content that may increase influence on purchasers as a content creator (e.g., influencer) through the consulting information.

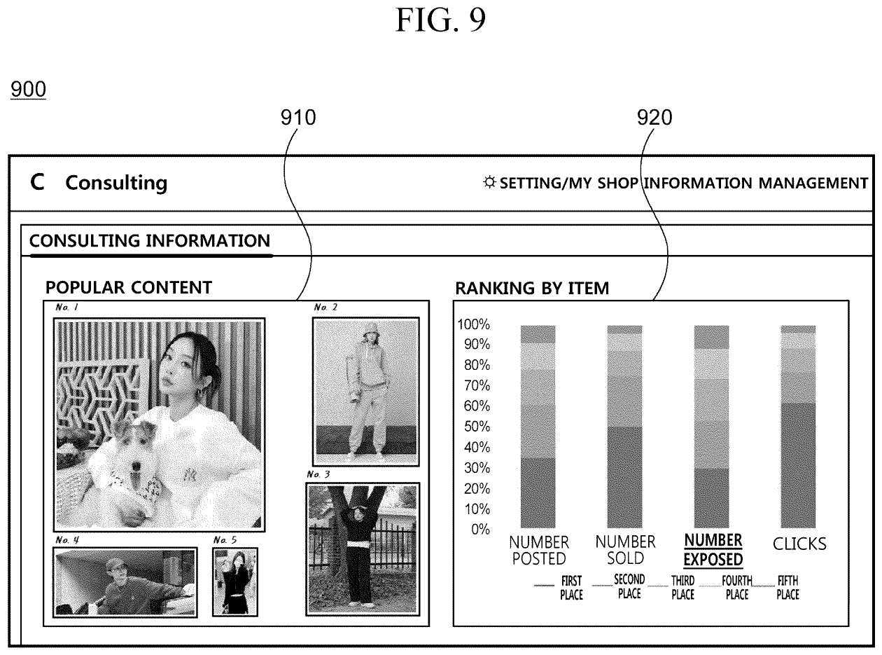

According to one embodiment, the processor 130 may provide the generated consulting information to the content creator. For example, the processor 130 may provide the consulting information through a GUI of a solution service provided to the content creator to supply content to a platform service. This will be described in more detail in FIG. 9.

According to one embodiment, the processor 130 may provide a purchaser with a service required to purchase a product through a purchaser terminal (e.g., the purchaser terminal 240 in FIG. 1). According to one embodiment, the processor 130 may receive purchase information about a purchaser who has purchased a product from the purchaser terminal. According to one embodiment, the processor 130 may transmit the received order information to the supplier terminal and the seller terminal when payment is completed. For example, the processor 130 may transmit the received order information to the supplier terminal to cause the supplier to deliver the product to the purchaser.

Accordingly, the e-commerce platform server 100 may provide the platform service for selling products online.

FIG. 3 is a diagram illustrating a hierarchy of sellers according to one embodiment.

Referring to FIG. 3, a plurality of sellers 310 may be registered in a hierarchy including a top seller and a sub seller.

According to one embodiment, a plurality of sellers 310 may connect to a platform server (e.g., the platform server 100 in FIG. 1) through a seller terminal (e.g., the seller terminal 220 in FIG. 1) to transmit and receive information for using a platform service. The actions (or operations) of the plurality of sellers 310 below may be understood as being performed through seller terminals.

According to one embodiment, the hierarchy of the plurality of sellers 310 may include an upper seller and a sub seller subordinate to the upper seller. The sub seller being subordinate to the upper seller may mean that the authority of the sub seller within the platform service is subordinate to the authority of the upper seller. In other words, being subordinate may mean that the authority of the sub seller may be determined within the authority of the upper seller. The authority may relate to the scope of determination that may be made when a product is registered in the platform service and is sold, for example, whether the seller is registered, products to be sold, sales conditions, or the like.

According to one embodiment, the hierarchy of a plurality of sellers 310 may include a plurality of layers. For example, each of the plurality of layers may be sequentially subordinate to a higher layer. According to one embodiment, the hierarchy of the plurality of sellers 310 may include a master seller 311, a manager seller 313, and a general seller 315. In addition, the hierarchy of the plurality of sellers 310 may include three or more layers. For example, the hierarchy the plurality of sellers 310 may register the manager seller 313 including a plurality of layers.

According to one embodiment, the master seller 311 may be the top seller in the hierarchy. In other words, the master seller 311 may not have an upper seller to whom the master seller is subordinate.

According to one embodiment, the master seller 311 may register a sale product in the platform service. The sale product may be, for example, at least one of supply products registered in the platform service by suppliers.

According to one embodiment, the master seller 311 may manage subordinate sub sellers (or the manager seller 313 and the general seller 315).

According to one embodiment, the master seller 311 may determine whether to register subordinate sub sellers 313 and 315. For example, the master seller 311 may determine whether to register not only the manager seller 313, which is directly subordinate to the master seller, but also the general seller 315, which is indirectly subordinate to the master seller through the manager seller 313.

According to one embodiment, the master seller 311 may set the earning rate for the sub sellers 313 and 315. The earning rate may be, for example, a proportion in which the profit from the sale of products by sub sellers 313 and 315 are distributed according to the hierarchy. According to one embodiment, the sales money of the product may be distributed to the supplier, the seller, and the content creator. For example, the sales money of the product may be distributed according to the contributions of the supplier, the seller, and the content creator to product sales. According to one embodiment, the profit distributed to the seller in the hierarchy may be the amount obtained by excluding the amounts distributed to the supplier and the content creator. The amount distributed to the supplier may be, for example, a supply amount of the product. The amount distributed to the content creator may be a reward amount for content creation. According to one embodiment, the reward amount distributed to the content creator may be determined based on the extent to whom the created content contributes to product sales.

According to one embodiment, the master seller 311 may confirm a sales status, delivery status, and settlement status of the registered sub sellers 313 and 315.

According to one embodiment, the master seller 311 may create an online shop directly operated by the master seller 311. In the created online shop, for example, sale products of the master seller 311 may be registered. According to one embodiment, the master seller 311 may sell the products to a purchaser 320 through the created online shop.

According to one embodiment, rather than directly selling products to the purchaser 320 through the online shop, the master seller 311 may focus more on registration of the sale product and management of the subordinate sub sellers 313 and 315. According to one embodiment, since the profit of the master seller 311 may be distributed from the sales profit of the sub sellers 313 and 315 according to a set earning rate, the master seller 311 may focus on managing the sale products and sub sellers 313 and 315 rather than directly selling the products. Accordingly, the master seller 311 is the top seller in the hierarchy and may play a major role in registering sale products and managing sub sellers, thereby increasing the profit not only for himself but also for the entire seller group centered on the master seller 311.

According to one embodiment, the manager seller 313 may be a middle seller in the hierarchy. In other words, the manager seller 313 may have an upper seller to whom the manager seller is subordinate and a sub seller who is subordinate to the manager seller.

According to one embodiment, the manager seller 313 may manage a subordinate sub seller (or general seller 315). According to one embodiment, the manager seller 313 may determine whether to register the general seller 315 and confirm the sales status, delivery status, and settlement status of the general seller 315. In other words, the manager seller 313 may be granted a specified authority to manage the general seller 315.

According to one embodiment, the manager seller 313 may create an online shop directly operated by the manager seller 313. According to one embodiment, the manager seller 313 may sell products within the registered sale products of the master seller 311. According to one embodiment, the manager seller 313 may sell the products to the purchaser 320 through the created online shop.

According to one embodiment, the manager seller 313, like the master seller 311, may focus more on management of the subordinate general seller 315 rather than directly selling products to the purchaser 320 through the online shop. According to one embodiment, since the profit of the manager seller 313 may be distributed from the sales profit of the general seller 315 according to the set earning rate of the master seller 311, the master seller 311 may focus more on the management of the general seller 315 rather than directly selling the products. Accordingly, the manager seller 313 is a middle seller in the hierarchy, and may perform a main role (or middle manager role) of managing the general seller 315, thereby increasing the profit of not only the manager seller but also the entire seller group centered on the master seller 311.

According to one embodiment, the general seller 315 may be the lowest seller in the hierarchy. In other words, the general seller 315 may not have a subordinate sub seller.

According to one embodiment, the general seller 315 may create an online shop in which at least one sale product of the master seller 311 is registered. According to one embodiment, the general seller 315 may sell products within the registered sale products of the master seller 311. According to one embodiment, the general seller 315 may sell the products to the purchaser 320 through the created online shop.

According to one embodiment, the general seller 315, unlike the upper sellers 311 and 313, may focus more on directly selling products to the purchaser 320 through the online shop. According to one embodiment, the general seller 315 may select at least one product to be sold in his/her online shop among the products registered by the master seller 311. For example, the general seller 315 may sell products with expertise or select products that have a high sales rate when sold together. For example, the products with a high sales rate when sold together may be products that visitors to the online shop are likely to purchase together. According to one embodiment, the general seller 315 may set the design of the online shop that will sell the selected product. For example, the general seller 315 may set a layout of a configuration of the online shop and the contents included in the configuration (e.g., product classification, list, description, and the like). Accordingly, the general seller 315 is the lowest seller in the hierarchy and may perform the main role of selling products.

According to one embodiment, a platform server (e.g., the platform server 100 in FIG. 1) may determine a contribution for distributing a profit from product sales to a content creator based on a role of a seller according to the hierarchy. According to one embodiment, the platform server may determine the contribution of the content creator by comparing the sales amount of each of a plurality of sellers depending on whether or not the content is used. For example, the platform server may determine the contribution of the content creator by comparing the sales amounts of sub sellers (e.g., the general sellers 315). For example, a difference in the sales amounts of the plurality of sellers may occur depending on whether or not the specified content is used, and when the difference is large, the contribution of the content creator may be determined to be high. According to one embodiment, as described with reference to FIG. 2, the platform server may generate consulting information helpful in creating content based on data on the profit distributed according to the determined contribution.

According to one embodiment, the platform server may determine at least one content item for generating the consulting information helpful in creating content, based on the role of the seller according to the hierarchy. For example, the platform server may determine at least one content item among the content items registered on the platform service based on the role of the seller according to the hierarchy. For example, the determined at least one content item may be a content item whose promotional effect may be compared with the content of a specified content creator. According to one embodiment, the platform server may determine the at least one content item based on the hierarchy of sellers selling the product through the page where the content of the specified content creator is posted. For example, the platform server may determine content related to sub sellers (e.g., the general sellers 315) in the hierarchy that includes sellers selling products using the content, as the at least one content item. The content related to the sub sellers may be, for example, content posted on at least one of sales pages of online shops of the sub sellers, and the content page of the content creator linked to the sales pages. Accordingly, the content creator may receive the consulting information generated based on the data for the determined at least one content item.

According to one embodiment, due to the nature of the hierarchy of sellers, since the main role of the general seller 315 is to sell products, a difference between content items may be clearly confirmed in data that confirms a content usage status and the promotional effect depending on the type of content (e.g., the sales amount, number of times the content is posted, or the like). On the other hand, since the data may be distorted as the master seller 311 and the manager seller 313 focus on roles other than product sales, the difference may not be clearly confirmed. According to one embodiment, since in the platform service, the roles of sellers are clearly divided according to the hierarchy, data for accurately analyzing the effect of content may be obtained more easily than in other platforms. Accordingly, it may be possible to generate consulting information that is actually helpful in content creation.

FIG. 4 is a diagram illustrating a plurality of seller groups included in a hierarchy of sellers according to one embodiment.

Referring to FIG. 4, the hierarchy of the plurality of sellers 400 may include one or more seller groups 410 and 420. Each of the one or more seller groups 410 and 420 may include at least one sub seller subordinate to the top seller centered on the top seller.

According to one embodiment, the seller groups 410 and 420 of the plurality of sellers 400 may include the top seller and at least one sub seller subordinate to the top seller. For example, the seller groups 410 and 420 of the plurality of sellers 400 may include master sellers 411 and 421, a plurality of manager sellers 413 and 423 subordinate to the master sellers 411 and 421, and a plurality of general sellers 415 and 425 subordinate to the plurality of manager sellers 413 and 423, respectively.

According to one embodiment, a plurality of sellers 411, 413, and 415 included in the first seller group 410 may sell sale products of the first master seller 411. According to one embodiment, the first master seller 411 is a top seller of the first seller group 410 and may register sale products sold by the plurality of sellers 411, 413, and 415 included in the first seller group 410. The registered sale products of the first master seller 411 may include, for example, a product (e.g., sportswear) included in the same category (e.g., clothing) and a product (e.g., sneakers) that, even when they are in a different category (e.g., shoes), is highly relevant to each other. According to one embodiment, a platform server (e.g., the platform server 100 in FIG. 1) may register products that are highly relevant to each other in order to secure the expertise of the sellers. The registration may be approved, for example, by a manager of the platform server. According to one embodiment, each of a plurality of first manager sellers 413 may manage sales of a plurality of first general sellers 415 that are subordinate to the first manager seller. According to one embodiment, the plurality of first general sellers 415 may sell at least one product registered by the first master seller 411 through an online shop. In addition, as described with reference to FIG. 3, the first master seller 411 and the plurality of first manager sellers 413 may also sell registered products through their respective online shops.

According to one embodiment, a plurality of sellers 421, 423, and 425 included in the second seller group 420 may sell sale products of the second master seller 421. According to one embodiment, the second master seller 421 is a top seller of the second seller group 420 and may register sale products sold by the plurality of sellers 421, 423, and 425 included in the second seller group 420. For example, the registered sale products sold by the second master seller 421 are included in the same category (e.g., clothing) as some sale products (e.g., sportswear) of the first seller group 410, but may include products (e.g., casual wear) with low relevance. According to one embodiment, each of a plurality of second manager sellers 423 and a plurality of second general sellers 425 may manage subordinate sub sellers and sell products, similarly to the first seller group 410.

According to one embodiment, a platform server (e.g., the platform server 100 in FIG. 1) may determine at least one content item for generating consulting information helpful in creating content based on the seller group. For example, the platform server may determine at least one content item among the content items registered on the platform service based on the seller group. For example, the determined at least one content item may be a content item whose promotional effect may be compared with the content of a specified content creator. According to one embodiment, the platform server may determine the at least one content item based on the hierarchy of sellers selling the product through the page where the content of the specified content creator is posted. For example, the platform server may determine, as the at least one content item, content related to a seller group (e.g., first seller group 410) that includes sellers selling products through a page where the content is posted. The content related to the seller group may be, for example, content posted on at least one of sales pages of the online shops of the plurality of sellers (e.g., the first master seller 411, the plurality of first manager sellers 413, and the plurality of first general sellers 415) included in the seller group, and content pages linked to the sales pages. As described with reference to FIG. 3, the plurality of sellers may be sub sellers (e.g., the plurality of first general sellers 415) included in the seller group. Accordingly, the content creator may receive the consulting information generated based on the at least one piece of content data.

According to one embodiment, due to the nature of the seller group selling sale products of the top seller (e.g., master sellers 411 and 421), the content used to sell products within the same seller group (e.g., first seller group 410) as the content of the specified content creator may be content corresponding to products that are highly relevant to each other (e.g., sportswear and sneakers). Accordingly, the consulting information generated based on data for the content within the same seller group may be helpful to the specified content creator even when the consulting information is generated based on data for content corresponding to products of different categories (e.g., clothing and shoes). On the other hand, the content used to sell products (e.g., casual clothes) within a seller group (e.g., the second seller group 420) that is different from the content of the specified content creator may not be helpful to the specified content creator even when the consulting information is generated based on data for content corresponding to products of the same category (e.g., clothing).

According to one embodiment, as described with reference to FIG. 2, the product category may also be a criterion for determining the content capable of being compared to the specified content in terms of promotional effect to generate the consulting information, but even though products are categorized in the same category (e.g., clothing), there may also be lower-level products (e.g., sportswear and casual wear). Accordingly, the seller group selling products that are highly relevant to each other may be used as another criterion for generating the consulting information. In addition, the seller group as the criterion for distinguishing related content may be more useful because no separate process is required to determine the criterion. This will be described in more detail in FIG. 5B.

FIGS. 5A and 5B are diagrams illustrating a process in which content is provided on an e-commerce platform according to one embodiment.

Referring to FIG. 5A, a platform server (e.g., the platform server 100 in FIG. 1) may provide consulting information generated using data collected in a process of selling a product of a supplier 510 on a platform service 500 through an online shop of a seller 530 using content provided by a content creator 520.

According to one embodiment, in step 511, the supplier 510 may register a supply product in the platform service 500. The registered supplied product may be, for example, a product to be sold on the platform service 500.

According to one embodiment, in step 521, the content creator 520 may create content to promote the registered supply product. For example, the content may be created upon request through product sponsorship by the supplier 510.

According to one embodiment, in step 523, the content creator 520 may register the created content in the platform service 500. For example, the registered content may be posted on at least one page on the platform service 500.

According to one embodiment, in step 525, the content creator 520 may post the created content on a content page. The content page, for example, is a page where the content creator 520 who has created the content is identifiable, and a plurality of content items created by the content creator 520 may be posted thereon.

According to one embodiment, in step 531, the seller 530 may register the supply product registered by the supplier 510 in step 511 as a sale product. For example, a top seller may register products to be sold in online shops of the subordinate sub sellers.

According to one embodiment, in step 533, the seller 530 may create an online shop to sell the registered product. For example, the online shop may include a corresponding page for selling at least one product.

According to one embodiment, in step 535, the seller 530 may select content registered in step 523 to sell the product using the content for the sale product. For example, the selected content may be posted on the sales page of the online shop, or the content posted on the content page of the content creator 520 may be set to be linked to the sales page.

According to one embodiment, in step 537, the seller 530 may sell the product through the created online shop. For example, the seller 530 may sell the product through the sales page of the online shop where the content for the product is posted. For another example, the seller 530 may sell the product through the content page of the content creator 520 linked to the sales page. A purchaser (e.g., the purchaser 320 in FIG. 3) may purchase the product by accessing the sales page through the content page.

According to one embodiment, in step 540, the platform server may distribute the profit of the sold product. For example, the platform server may distribute the profit from selling the product to the content creator 520 and the seller 530. The profit from selling the product may be, for example, the price at which the product has been sold minus the supply price of the product. According to one embodiment, the supply price may be distributed to the supplier 510.

According to one embodiment, in step 550, the platform server may provide consulting information helpful in creating content to the content creator using data collected in the process of selling the product.

Referring to FIG. 5B, the platform server may generate consulting information based on data collected in the process of selling the product using content.

According to one embodiment, in step 551, the platform server may determine at least one content item related to content of a specified content creator among a plurality of content items registered in content DB 551a of the platform service. According to one embodiment, the platform server may determine at least one content item related to the content of the specified content creator among the plurality of content items based on a product category 551b. For example, the platform server may determine content corresponding to a product in the same category as the product corresponding to the content of the specified content creator as the at least one content item.

According to one embodiment, in step 553, the platform server may determine the product category 551b for classifying related content among the plurality of content items registered in the platform service.

According to one embodiment, in step 553_1, the platform server may analyze the plurality of content items and generate a deciding model 553a for products with similar content. For example, the platform server may generate the deciding model 553a capable of confirming products for which content is decided to be similar by considering not only elements about the content itself (e.g., similarity of images, type of content, or the like), but also additional elements such as an expert involved in creating the content (e.g., a hair and makeup expert, a stylist, a photographer, or the like). The content decided to be similar may, for example, have similar content creation methods, such as models, themes, planning, and filming. According to one embodiment, the platform server may generate the deciding model 553a by determining the weight of each element for confirming the similarity of the content through analysis of a plurality of content items. For example, the platform server may update the deciding model 553a by analyzing and learning continuously registered content and changing the weight.

According to one embodiment, in step 553_3, the platform server may determine a category 551b for determining related content through the deciding model 553a for products with similar content. For example, the platform server may determine a concept that may encompass a plurality of products each classified as the product with similar content as the category 551b. According to one embodiment, the platform server may also continuously update the category 551b for determining related content by updating the deciding model 553a for products with similar content.

According to one embodiment, the platform server may determine content corresponding to the product of the same category as the content of the specified content creator as the at least one content item, according to the determined category 551b.

According to another embodiment, in step 551, the platform server may determine at least one content item related to the content of the specified content creator among the plurality of content items registered in the platform service, based on a hierarchy 551c of sellers. For example, the platform server may determine the at least one content item based on the hierarchy of sellers selling the product corresponding to the content through the page where the content of the specified content creator is posted. The hierarchy of sellers may include, for example, a seller group in which the seller is included, and superordinate/subordinate relationships between the sellers within the seller group. According to one embodiment, the method using the hierarchy 551c of sellers has an advantage in that it uses the hierarchy 551c of sellers, which is naturally formed in the process of selling products on the platform, even without going through a separate process to determine or update the category 551b in step 553.

According to one embodiment, in step 555, the platform server may collect data for generating consulting information in a process of selling a product through a page where the determined at least one content item is posted. According to one embodiment, the platform server may collect the data through the page where the at least one content item is posted. For example, the platform server may collect data (e.g., the number of times the content is viewed, the number of times the online shop is accessed, and the like) through the content page where the content is posted in step 525. For another example, the platform server may collect data (e.g., the number of times the content is posted, the number of times the product is sold, and the like) through a sales page where content is posted in step 535. According to one embodiment, the platform server may collect data on the profit distributed to the at least one content item in step 540.

According to one embodiment, in step 557, the platform server may generate consulting information based on the collected data. For example, the platform server may generate consulting information containing information on content of a specified rank or higher based on a specified numerical value on the data. According to one embodiment, the platform server may provide the generated consulting information to the specified content creator.

Accordingly, the content creator may receive consulting information that is actually helpful in creating content.

FIG. 6 is a view illustrating that a content creator's content is posted on a sales page of a seller's online shop according to one embodiment.

Referring to FIG. 6, a platform server (e.g., the platform server 100 in FIG. 1) may post content 610 of a content creator (e.g., the content creator 520 in FIG. 5A) on a sales page 600 of an online shop.

According to one embodiment, the platform server may post golf wear top content 610 of the content creator on a golf wear top sales page 600 of an online shop of a seller (e.g., the seller 530 in FIG. 5A). The posted golf wear top content 610 may be an image of a content creator (e.g., a model) wearing a golf wear top to promote the golf wear top. According to one embodiment, the platform server may post the golf wear top content 610 together with product information 620 on golf wear. The product information 620 posted together may be, for example, the image of a golf wear top to describe the golf wear top.

According to one embodiment, the platform server may sell the golf wear top through the sales page 600 of the online shop where the golf wear top content 610 is posted.

According to one embodiment, the platform server may generate consulting information provided to a content creator who creates content for tennis wear tops, based on data collected through the sales page 600 for the golf wear top. For example, the platform server may generate the consulting information based on data collected through the sales page 600 where the golf wear top content 610 of the same clothing category as tennis wear tops is posted. For another example, the platform server may generate the consulting information based on data collected through the sales page 600 where the golf wear top content 610 that is highly relevant to a seller group including a seller using tennis wear top content is posted. The data may include, for example, the number of times the golf wear top content 610 is posted on the sales page 600 of the online shop and sales pages of other online shops, and the number of times the product is sold through the posted sales pages. According to one embodiment, the platform server may generate consulting information including information on content at a specified rank or higher based on at least one of the data and the number of times the content is posted and the number of times the product is sold on the data.

Accordingly, the platform server may provide consulting information for creating content using data collected through the sales page 600 of the online shop.

FIGS. 7A and 7B are views illustrating that content is posted on a content creator's content page according to one embodiment.

Referring to FIG. 7A, a platform server (e.g., the platform server 100 in FIG. 1) may post a plurality of content items 711 of a content creator (e.g., the content creator 520 in FIG. 5A) on a content page 710.

According to one embodiment, the platform server may post golf wear top content 711a on the content creator's content page 710. The posted golf wear top content 711a may be an image of the content creator (e.g., model) wearing a golf wear top, as described with reference to FIG. 6. According to one embodiment, the platform server may post a plurality of content items 711 of the content creator, including the golf were top content 711a, on the content page 710. The plurality of posted content items 711 may include, for example, golf wear bottom content, training suit content, and the like.

Referring to FIG. 7B, the platform server may post content information 711a′ together with content 711a on the content page 710.

According to one embodiment, the platform server may post the content information 711a′ together with the golf wear top content 711a on the content page 710. The posted content information 711a′ may include, for example, information S about an expert (e.g., a model, a hair and makeup expert, a stylist, a photographer, or the like) who has participated in creating the content 711a and product information P included in content 711a, including golf wear tops. According to one embodiment, when the platform server receives a user input for selecting the golf wear top content 711a from a plurality of content items 711 posted on the content page 710 from a platform user (e.g., a purchaser), the platform server may provide the content information 711a′ together with the golf wear top content 711a to the platform user.

According to one embodiment, the platform server may set the content page to be linked to a sales page 720 (e.g., the sales page 600 in FIG. 6) that sells a product through the product information P. For example, the platform server may set the content page to be linked to the sales page C through product information P′ about golf wear tops. According to one embodiment, when the platform server receives a user input for selecting product information P′ about golf wear tops from the platform user, the platform server may provide the sales page 720 of golf wear tops to the platform user. The provided sales page 720 of golf wear tops may include, for example, golf wear top content 721, as described with reference to FIG. 6. According to one embodiment, the platform server may provide a golf wear top sales service to the platform user through the sales page 720.

According to one embodiment, similarly to the sales page 600 of FIG. 6, the platform server may generate consulting information provided to the content creator who has created content for tennis wear tops, based on data collected from the content page 710 where golf wear tops are posted. For example, the platform server may generate the consulting information based on data collected through the content page 710 where the golf wear top content 721, which is in the same clothing category as tennis wear tops or is highly relevant to a seller group that includes a seller using the content, is posted. The data may include, for example, the number of times golf wear content is viewed by users on the platform service, and the number of times the viewing users access the product sales page through the golf wear content. According to one embodiment, the platform server may generate consulting information including information on content at a specified rank or higher based on at least one of the data and the number of times the content is viewed and the number of times the users access the sales page on the data.

Accordingly, the platform server may provide consulting information for creating content using data collected through the content page 710 of the online shop.

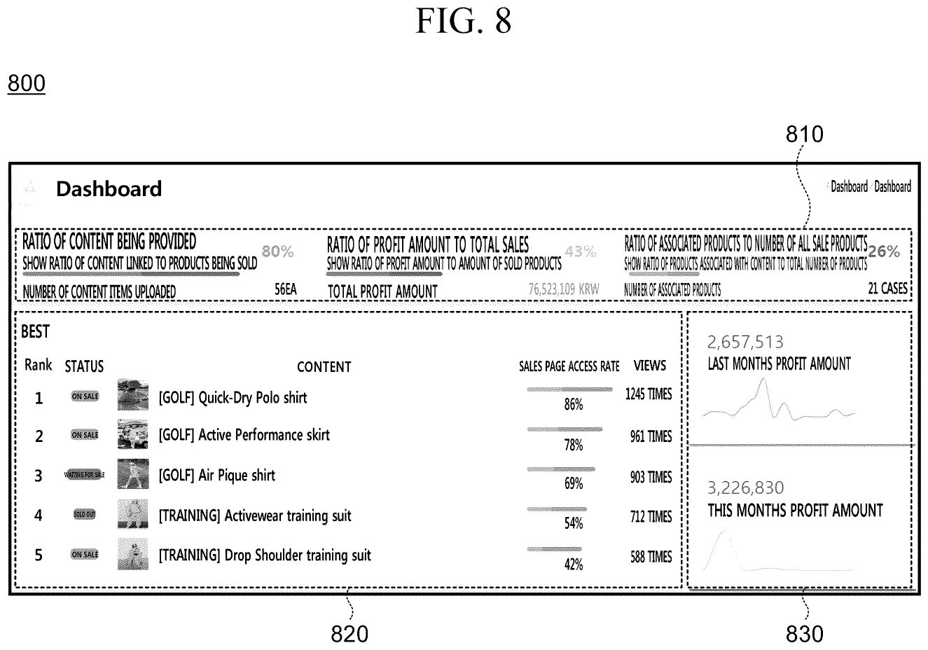

FIG. 8 is a view illustrating a graphic user interface (GUI) that provides status information about a content creator according to one embodiment.

Referring to FIG. 8, a platform server (e.g., the platform server 100 in FIG. 1) may provide status information about a content creator through a content status management GUI 800.

According to one embodiment, the platform server may provide overall status information 810 of the content being provided. For example, the platform server may provide information on a ratio of content linked to a sale product, an average profit distribution ratio of content linked to the sale product, a ratio of the sale product linked to content to all sold products, or the like.

According to one embodiment, the platform server may provide status information 820 about each content item being provided. For example, the platform server may provide information about the status of an individual content item linked to the sale product, a ratio of moving to a sales page after viewing, the number of views, or the like.

According to one embodiment, the platform server may provide profit information 830 according to content provision. For example, the platform server may provide information about the profit settled on a monthly basis (e.g., last month and this month).

Accordingly, the content creator may easily confirm status information about the provided content through the content status management GUI 800.

FIG. 9 is a view illustrating a GUI that provides consulting information to a content creator according to one embodiment.

Referring to FIG. 9, a platform server (e.g., the platform server 100 in FIG. 1) may provide consulting information for creating content through a consulting GUI 900.

According to one embodiment, the platform server may provide a plurality of content items 910 that may be compared to content of a specified content creator. For example, the platform server may provide a plurality of content items 910 of a specified rank (e.g., fifth place) or higher based on at least one of the number of times the product is posted on a sales page (e.g., the sales page 600 in FIG. 6), and the number of times the product is sold through the sales page. For another example, the platform server may provide a plurality of content items 910 of a specified rank or higher based on the number of times content of a content page (e.g., content page 710 in FIG. 7) is viewed by users on the platform service and the number of times the viewing users access the sales page through the content. The at least one content item may represent, for example, that corresponding products are products of the same category, or represent products that are highly relevant and are registered as sale products of the same seller group.

According to one embodiment, the platform server may provide information 920 on the plurality of content items. For example, the platform server may provide the information about the number of times the at least one content item is posted on the sales page, the number of times the product is sold through the sales page, the number of times the content is viewed on the content page, and the number of times the sales page is accessed through the content page.

Accordingly, the content creator may receive consulting information helpful in creating content through the consulting GUI 900.

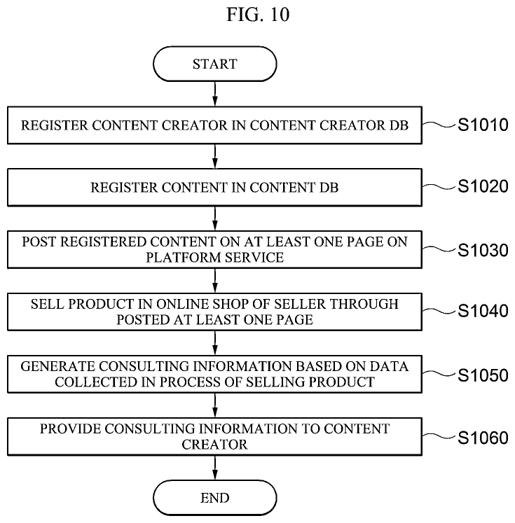

FIG. 10 is a flowchart showing a method of providing consulting information to a content creator according to one embodiment.

According to one embodiment, in step S1010, a platform server (e.g., the platform server 100 in FIG. 1) may register a content creator who provides content for selling products to a platform service in a content creator DB. For example, the platform service may be an e-commerce service that sells a suppliers' products through sellers' online shops. According to one embodiment, the platform server may sell products from suppliers registered in the platform service through an online shop on the platform service. For example, the online shop may be an online shop of a seller registered in the platform service.

According to one embodiment, in step S1020, the platform server may register content provided by the registered content creator in a content DB. For example, the content is content created by the content creator and may include images such as photos, videos, or the like, to promote a specified product.

According to one embodiment, in step S1030, the platform server may post the registered content on at least one page on the platform service. For example, the platform server may post the content on a sales page of an online shop that sells a product corresponding to the content. For another example, the platform server may post the content on a content page of the content creator who has created the content.

According to one embodiment, in step S1040, the platform server may sell the product in the seller's online shop through at least one page posted above. For example, the platform server may sell the product through a sales page of the online shop where the content is posted. For another example, the platform server may sell the product through the content page of the content creator where the content is posted. For example, the content page may be linked to a sales page for selling a product corresponding to the posted content.

According to one embodiment, in step S1050, the platform server may generate consulting information for producing content based on data collected in a process of selling the product.

According to one embodiment, the platform server may determine at least one content item among a plurality of content items registered in the content DB based on the content of a specified content creator. For example, the at least one content item may be a content item of which a promotional effect may be compared.

According to one embodiment, the platform server may determine the at least one content item based on a product corresponding to the content of the specified content creator. For example, the platform server may determine content corresponding to a product of the same category as the product corresponding to the content as the at least one content item.

According to another embodiment, the platform server may determine the at least one content item based on a hierarchy of sellers selling the product corresponding to the content of the content creator. For example, the platform server may determine content related to a seller group of the seller as the at least one content item. The content related to a seller group may be, for example, content posted on at least one of sales pages of online shops of a plurality of sellers included in the seller group, and a content page of the content creator linked to the sales pages. According to one embodiment, the platform server may determine content posted in at least one of a sales page and a content page of a sub seller among the sellers included in the seller group as the at least one content item.

According to one embodiment, the platform server may generate the consulting information based on data collected in the process of selling the product through a page where the at least one content item is posted.

According to one embodiment, the platform server may generate the consulting information based on data on the profit distributed to the at least one content item. For example, the platform server may generate the consulting information including data on the profit distributed to the at least one content item, and information on content with a distributed profit that is at a specified rank on the data.

According to one embodiment, the platform server may generate consulting information based on data collected through the sales page of the online shop where the at least one content item is posted. For example, based on data including the number of times the content is posted on the sales page of the online shop, and the number of times the product is sold through the posted sales page, the platform server may generate the consulting information including information on content that is at a specified rank or higher based on at least one of the data and the number of times the content is posted and the number of times the product is sold on the data.

According to one embodiment, the platform server may generate the consulting information based on data collected through the content page of the content creator where the at least one content item is posted. For example, based on data including the number of times the content is viewed by users on the platform service and the number of times the viewing users access the sales page through the content, the platform server may generate the consulting information including information on content at a specified rank or higher based on at least one of the data and the number of times the content is viewed on the data and the number of times the users access the sales page on the data.

According to one embodiment, in step S1060, the platform server may provide the generated content information to the content creator. For example, the platform server may provide the content information to the content creator through a content information GUI.

According to one embodiment, steps S1010 to S1060 may be implemented by a computer program stored in a computer-readable storage medium and configured to be executed by one or more processors. The computer program may include an instruction set in which steps S1010 to S1060 are implemented in a programming language.

Since in the platform server according to various embodiments as described with reference to FIGS. 1 to 10, an entire process of selling suppliers' products through an online shop of a seller using content provided by a content creator is entirely carried out on a platform, data for generating consulting information can be easily obtained through not only a sales page of the online shop where the content is posted, but also a content page of the content creator for social network services (SNSs), and even in a process of selecting content to obtain data, content whose promotional effect is able to be compared with a specified content can be easily determined using a category of products registered in the platform service and a hierarchy of sellers, that is, material and human resource information, thereby providing the content creator with practically helpful consulting information.

According to an embodiment disclosed herein, an e-commerce platform service provided through a platform server can allow suppliers, sellers, and content creators for distributing and selling products to gather in one platform service, thereby easily finding experts outside their respective own areas and cooperating with each other to sell products. In addition, the e-commerce platform service can reduce risks that users who cooperate in selling products have to bear when selling products on their own, allow the users to do their best by focusing on their areas of expertise, and further promote product sales by distributing a sales profit according to a proportion of the contribution of the product sales, thereby creating a virtuous cycle structure in which each entity' profit increases and each entity develops in their own area. In addition, this virtuous cycle structure of the e-commerce platform service can form a healthy market that prevents damage to suppliers and sellers due to competition at the lowest price in existing open markets and provides high-quality products to purchasers at reasonable prices.

In addition, since in an e-commerce platform service of a platform server, an entire process of selling suppliers' products through an online shop of a seller using content provided by a content creator is entirely carried out on a platform, data for generating consulting information can be easily obtained through not only a sales page of the online shop where the content is posted, but also a content page of the content creator for social network services (SNSs), and even in a process of selecting content to obtain data, content whose promotional effect is able to be compared with a specified content can be easily determined using a category of products registered in the platform service and a hierarchy of sellers, that is, material and human resource information, thereby providing the content creator with practically helpful consulting information.

What is claimed is:

1. An e-commerce platform server comprising:
a communication device;
a memory configured to store one or more instructions; and
a processor configured to execute the one or more instructions stored in the memory,
wherein the processor executes the one or more instructions to:
register suppliers' supply products to be sold in an e-commerce platform service in a supply product database (DB);
register a plurality of sellers with a hierarchy including at least one top seller and at least one sub seller subordinate to the at least one top seller, respectively, in a seller DB, the sub seller being subordinate to the top seller to whom sale products and sales conditions of the products are subordinate;
register sale products of the top seller of the hierarchy in a sale product DB, the sale products being at least one of the supply products registered in the supply product DB;
create an online shop of the sub seller that includes at least one of the registered sale products of the top seller to whom the sub seller is subordinate;
register a content creator who provides content for selling products in a content creator DB in the e-commerce platform service;
register content provided by the content creator in a content DB;
post the content on at least one page on the e-commerce platform service;
sell a product in the created online shop through the at least one page;
generate consulting information for creating content based on data collected in a process of selling the product; and
provide the consulting information to the content creator.

2. The e-commerce platform server of claim 1, wherein the processor executes the one or more instructions to:
determine at least one content item among a plurality of content items registered in the content DB based on the content of the specified content creator;
generate consulting information based on data collected in the process of selling the product through a page where the at least one content item is posted; and
provide the consulting information to the specified content creator.

3. The e-commerce platform server of claim 2, wherein the processor executes the one or more instructions to determine the at least one content item based on a product corresponding to the content of the specified content creator.

4. The e-commerce platform server of claim 3, wherein the processor executes the one or more instructions to determine content corresponding to a product in the same category as the product corresponding to the content of the specified content creator as the at least one content item.

5. The e-commerce platform server of claim 4, wherein the processor executes the one or more instructions to:
determine a product category including a plurality of products corresponding to content items that are decided to be similar to each other by analyzing the plurality of content items registered in the content DB; and
determine content corresponding to a product of the same category as the at least one content item according to the determined category.

6. The e-commerce platform server of claim 5, wherein the processor executes the one or more instructions to:
generate a deciding model of a content similar product by analyzing the plurality of content items registered in the content DB; and
determine the category through the generated deciding model of the similar product.

7. The e-commerce platform server of claim 6, wherein the processor executes the one or more instructions to determine the deciding model of the similar product based on similarity of a type of content, an image included in the content, and an expert involved in creating the content.

8. The e-commerce platform server of claim 2, wherein the processor executes the one or more instructions to determine the at least one content item based on the hierarchy of sellers selling the product corresponding to the content through the page where the content of the specified content creator is posted.

9. The e-commerce platform server of claim 8, wherein the hierarchy of the plurality of sellers includes at least one seller group, and each of the at least one seller group includes at least one sub seller subordinate to the top seller centered on the top seller, and
the processor executes the one or more instructions to determine, as the at least one content item, content related to a seller group that includes a seller selling the product corresponding to the content.

10. The e-commerce platform server of claim 9, wherein the content related to a seller group is content posted on at least one of sales pages of online shops of a plurality of sellers included in the seller group, and a content page of the content creator linked to the sales pages.

11. The e-commerce platform server of claim 2, wherein the processor executes the one or more instructions to:
distribute a profit of the product sold through the at least one page to the content creator in a specified proportion; and
generate consulting information including data on the profit distributed by selling the product through a page where the at least one content item is posted, and information on content with a distributed profit that is at a specified rank or higher on the data.

12. The e-commerce platform server of claim 2, wherein the processor executes the one or more instructions to:
post the content on a sales page of at least one online shop selling the product corresponding to the content; and
generate the consulting information based on data collected through the sales page.

13. The e-commerce platform server of claim 12, wherein the data includes the number of times the content is posted on the sales page of the online shop, and the number of times the product is sold through the posted sales page, and
the processor executes the one or more instructions to generate consulting information including information on content at a specified rank or higher based on at least one of the data and the number of times the content is posted and the number of times the product is sold on the data.

14. The e-commerce platform server of claim 2, wherein the processor executes the one or more instructions to:
post the content on a content page of at least one content creator corresponding to the content; and
generate the consulting information based on data collected through the content page.

15. The e-commerce platform server of claim 14, wherein the data includes the number of times the content is viewed by users on the platform service, and the number of times the viewing users access the sales page through the content, and
the processor executes the one or more instructions to generate consulting information including information on content at a specified rank or higher based on at least one of the data and the number of times the content is viewed and the number of times the users access the sales page on the data.

16. A method of operating a server that provides an e-commerce platform service, the method comprising:
registering suppliers' supply products to be sold in an e-commerce platform service in a supply product database (DB);
registering a plurality of sellers with a hierarchy including at least one top seller and at least one sub seller subordinate to the at least one top seller, respectively, in a seller DB, the sub seller being subordinate to the top seller to whom sale products and sales conditions of the products are subordinate;
registering sale products of the top seller of the hierarchy in a sale product DB, the sale products being at least one of the supply products registered in the supply product DB;
creating an online shop of the sub seller that includes at least one of the registered sale products of the top seller to whom the sub seller is subordinate;
registering a content creator who provides content for selling products in a content creator DB in the e-commerce platform service;
registering content provided by the content creator in a content DB;
posting the content on at least one page on the e-commerce platform service;
selling a product in the created online shop through the at least one page;
generating consulting information for creating content based on data collected in a process of selling the product; and
providing the consulting information to the content creator.

17. A computer program stored in a computer-readable storage medium and configured to be executed by one or more processors, the computer program comprising:
an instruction to register suppliers' supply products to be sold in an e-commerce platform service in a supply product database (DB);
an instruction to register a plurality of sellers with a hierarchy including at least one top seller and at least one sub seller subordinate to the at least one top seller, respectively, in a seller DB, the sub seller being subordinate to the top seller to whom sale products and sales conditions of the products are subordinate;
an instruction to register sale products of the top seller of the hierarchy in a sale product DB, the sale products being at least one of the supply products registered in the supply product DB;
an instruction to create an online shop of the sub seller that includes at least one of the registered sale products of the top seller to whom the sub seller is subordinate;
an instruction to register a content creator who provides content for selling products in a content creator DB in the e-commerce platform service;
an instruction to register content provided by the content creator in a content DB;
an instruction to post the content on at least one page on the e-commerce platform service;
an instruction to sell a product in the created online shop through the at least one page;
an instruction to generate consulting information for creating content based on data collected in a process of selling the product; and
an instruction to provide the consulting information to the content creator.
